(19) United States
(12) Patent Application Publication
(10) Pub. No.: US 2008/0242350 A1
(43) Pub. Date: Oct. 2, 2008

(54) Obtaining network information for seamless vertical handovers

(76) Inventors: Vivek Gupta, Portland, OR (US); Sangeetha Bangolae, Beaverton, OR (US)

Correspondence Address: CAVEN & AGHEVLI;c/o INTELLEVATE, LLC, P.O. BOX 52050, MINNEAPOLIS, MN, 55402, US

(21) Appl. No.: 11/731,744

(22) Filed: Mar. 30, 2007

(51) Int. Cl. H04M 1/00

(52) U.S. Cl. 455/556.1

(57) ABSTRACT

Methods and apparatus to obtain network information for seamless vertical handovers are described. In one embodiment, a wireless device transmits an information query to an information server to cause the information server to determine one or more available access networks for the wireless device (e.g., as the wireless device moves toward one of the available access networks). Other embodiments are also described.

### BACKGROUND

The present disclosure generally relates to the field of electronics. More particularly, an embodiment of the invention generally relates to techniques for obtaining network information for seamless vertical handovers.

Wireless networks have become an integral part of computing. Some proposed wireless networks may utilize a centralized server to transmit information regarding available wireless networks to a mobile node. However, transmitting the information to the mobile node may consume valuable network bandwidth, cause latency, and/or increase power consumption by the mobile node.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1-3 illustrate various components of embodiments of communication systems, which may be utilized to implement one or more embodiments.

FIG. 4 illustrates a flow diagram of a method, according to an embodiment of the invention.

FIG. 5 illustrates a block diagram of an embodiment of a computing system, which may be utilized to implement various embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

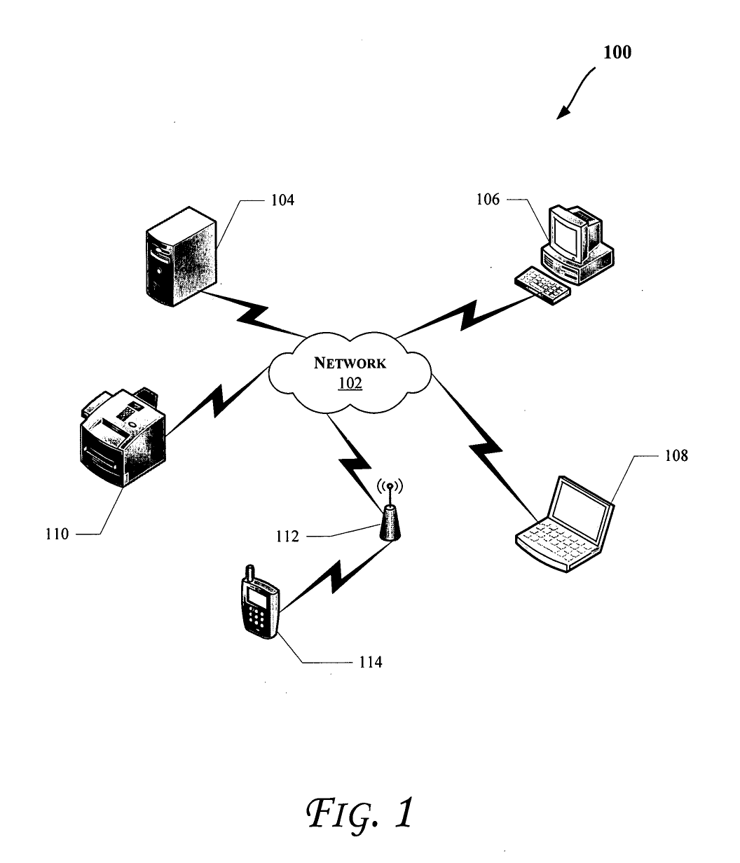

Some of the embodiments discussed herein may be applied in various computing environments such as those discussed with reference to FIGS. 1-5. More particularly, FIG. 1 illustrates various components of an embodiment of a communication system 100, which may be utilized to implement some embodiments discussed herein. The system 100 may include a network 102 to enable communication between various devices such as a server computer 104, a desktop computer 106 (e.g., a workstation or a desktop computer), a laptop (or notebook) computer 108, a reproduction device 110 (e.g., a network printer, copier, facsimile, scanner, all-in-one device, etc.), a Point of Attachment (PoA) 112 (such as a base station (BS), an access point (AP), etc.), a personal digital assistant or smart phone 114, a rack-mounted computing system (not shown), etc. The network 102 may be any type of a computer network including an intranet, the Internet, and/or combinations thereof.

The devices 104-114 may communicate with the network 102 through wired and/or wireless connections. Hence, the network 102 may be a wired and/or wireless network. For example, as illustrated in FIG. 1, the wireless access point 112 may be coupled to the network 102 to enable other wireless-capable devices (such as the device 114) to communicate with the network 102. In some embodiments, more than one access point 112 may be in communication with the network 102. In one embodiment, the wireless access point 112 may include traffic management capabilities. Also, data communicated between the devices 104-114 may be encrypted (or cryptographically secured), e.g., to limit unauthorized access.

The network 102 may utilize any communication protocol such as Ethernet, Fast Ethernet, Gigabit Ethernet, wide-area network (WAN), fiber distributed data interface (FDDI), Token Ring, leased line, analog modem, digital subscriber line (DSL and its varieties such as high bit-rate DSL (HDSL), integrated services digital network DSL (IDSL), etc.), asynchronous transfer mode (ATM), cable modem, and/or FireWire.

Wireless communication through the network 102 may be in accordance with one or more of the following: wireless local area network (WLAN), wireless wide area network (WWAN), wireless metropolitan area network (WMAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), etc. Moreover, network communication may be established by internal network interface devices (e.g., present within the same physical enclosure as a computing system) such as a network interface card (NIC) or external network interface devices (e.g., having a separate physical enclosure and/or power supply than the computing system to which it is coupled).

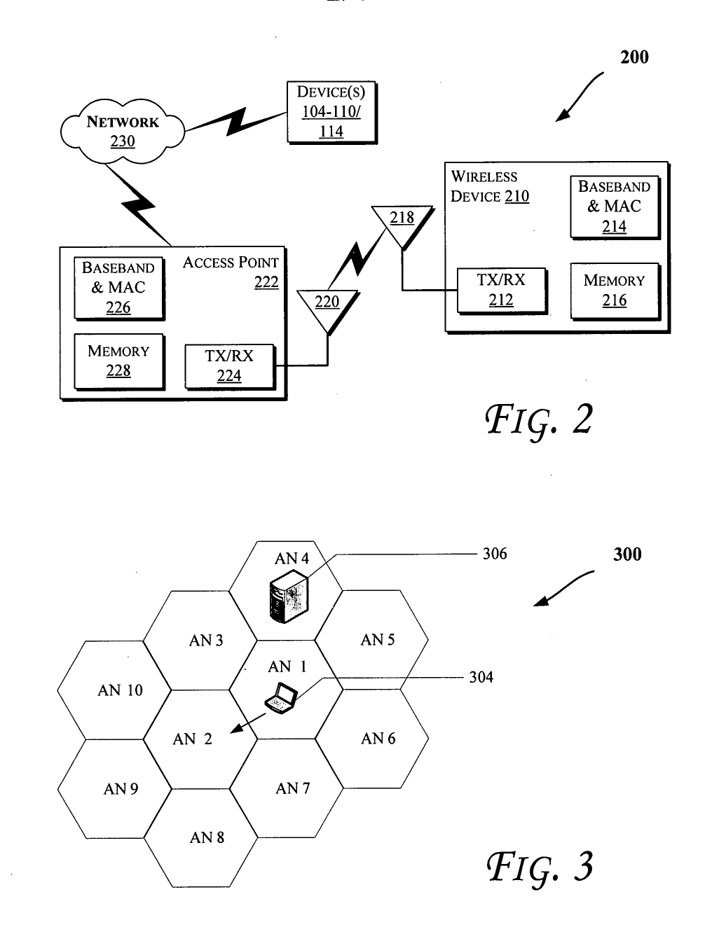

Referring to FIG. 2, a block diagram of a wireless local area or cellular network communication system 200 in accordance with one or more embodiments of the invention will be discussed. In the communication system 200 shown in FIG. 2, a wireless device 210 may include a wireless transceiver 212 to couple to an antenna 218 and to a logic 214 such as a processor (e.g., to provide baseband and media access control (MAC) processing functions). In some embodiment, one or more of the devices 104, 106, 108, 110, or 114 of FIG. 1 may include one or more of the components discussed with reference to the wireless device 210. Hence, in an embodiment, the devices 104, 106, 108, 110, or 114 of FIG. 1 may be the same or similar to the wireless device 210. In one embodiment of the invention, wireless device 210 may be a cellular telephone or an information handling system such as a mobile personal computer or a personal digital assistant or the like that incorporates a cellular telephone communication module. Logic 214 in one embodiment may comprise a single processor, or alternatively may comprise a baseband processor and an applications processor. Logic 214 may couple to a memory 216 which may include volatile memory such as dynamic random-access memory (DRAM), non-volatile memory such as flash memory, or alternatively may include other types of storage such as a hard disk drive. Some portion or all of memory 216 may be included on the same integrated circuit as logic 214, or alternatively some portion or all of memory 216 may be disposed on an integrated circuit or other medium, for example a hard disk drive, that is external to the integrated circuit of logic 214.

Wireless device 210 may communicate with access point 222 via a wireless communication link, where access point 222 may include one or more of: an antenna 220, a transceiver 224, a processor 226, and a memory 228. In one embodiment, access point 222 may be a base station of a cellular telephone network, and in another embodiment, access point 222 may be a an access point or wireless router of a wireless local or personal area network. In some embodiment, the access point 112 of FIG. 1 may include one or more of the components discussed with reference to the access point 222. Hence, in an embodiment, the access point 112 of FIG. 1 may be the same or similar to the access point 222. In an embodiment, access point 222 (and optionally wireless device 210) may include two or more antennas, for example to provide a spatial division multiple access (SDMA) system or a multiple input, multiple output (MIMO) system. Access point 222 may couple with network 230 (which may be the same or similar to the network 102 of FIG. 1 in some embodiments) so that wireless device 210 may communicate with network 230, including devices coupled to network 230 (e.g., one or more of the devices 104-114), by communicating with access point 222 via a wireless communication link. Network 230 may include a public network such as a telephone network or the Internet, or alternatively network 230 may include a private network such as an intranet, or a combination of a public and a private network. Communication between wireless device 210 and access point 222 may be implemented via a wireless local area network (WLAN). In one embodiment, communication between wireless device 210 and access point 222 may be at least partially implemented via a cellular communication network compliant with a Third Generation Partnership Project (3GPP or 3G) standard. In some embodiments, antenna 218 may be utilized in a wireless sensor network or a mesh network.

FIG. 3 illustrates various components of an embodiment of a communication system 300, which may be utilized to implement one or more embodiments of the invention. As shown in FIG. 3, the system 300 may include a plurality of access networks (ANs) which may be proximate to each other and/or overlapping in some embodiments. In some embodiments, the access networks may be adjacent, while in other embodiments the access networks may have a disjoint coverage. The access networks may be any type of a wireless network such as those discussed with reference to FIGS. 1-2. Also, even though FIG. 3 illustrates that access networks may have a similar coverage area (e.g., as illustrated by the hexagons in FIG. 3), depending on various parameters such as physical obstacles, network types, etc., the access networks may have differing signal coverage areas.

As illustrated in FIG. 3, a wireless device 304 (which may be one of the devices 210 of FIG. 2 and/or devices 104-110 or 114 of FIG. 1) may move between various access networks. For example, the device 304 may be moving from its currently serving access network (AN 1) towards another access network (AN 2) as indicated by the arrow in FIG. 3. Also, an information server (IS) 306 may communicate with the device 304 (e.g., through a wireless protocol such as those discussed with reference to FIGS. 1-2). In various embodiments, one or more of the devices 104 through 114 may be configured as an information server (e.g., as the server 306). In an embodiment, the IS 306 may share information in accordance with the proposed Institute of Electrical & Electronics Engineers (IEEE) 802.21 specification that is currently a work-in-progress such as IEEE P802.21-D04.00 specification (February 2007) (which may also be referred to as the media independent handover (MIH) specification). The location of IS 306 shown in FIG. 3 (i.e., within AN 4) is for exemplary purposes and the IS 306 may be located elsewhere in the system 300 or remote to the system 300. For example, the IS 306 may be located in the home network of the device 304 (e.g., AN 1), within another access network (e.g., which may be visited by the device 304), etc.

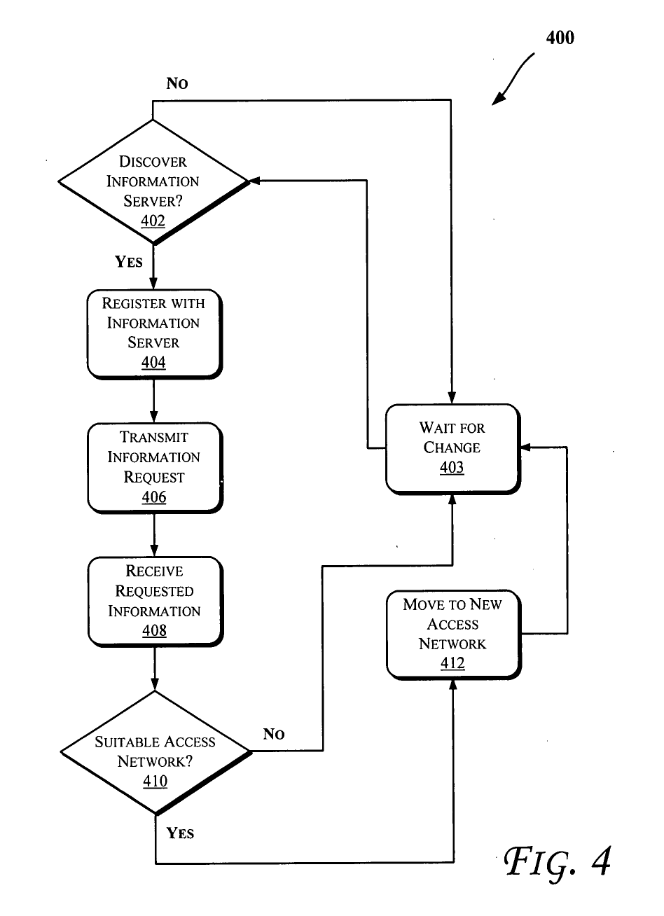

In some embodiments, the IS 306 may provide information about neighbor maps for different networks which may include information about link layer properties such as channel conditions, security, quality of service (QoS), operator identifiers, roaming agreements, etc. and also include information about available services from different networks. Such information may be utilized to support in seamless handovers in that the device 304 may access the IS 306 and obtain information about other networks using the existing network connection. This may allow the device 304 to assess other networks in terms of their suitability for supporting the current connection before actually considering handing over the current connection. Furthermore, the IS 306 may respond to queries by the device 304 as will be further discussed herein, e.g., with reference to FIG. 4.

In an embodiment, the wireless device 304 may retrieve different information elements (IEs) from the IS 306. Moreover, these IEs may be generic or specific to a particular access network such as: (1) list of available networks; (2) list of operators supporting a given network; (3) roaming agreements between operators; (4) neighbor report for a particular network; and/or (5) properties of a particular point of attachment (such as an access point or base station) for a particular network, etc.

FIG. 4 illustrates a block diagram of an embodiment of a method 400 to obtain network information for seamless vertical handovers in wireless networks. In an embodiment, various components discussed with reference to FIGS. 1-3 and 5 may be utilized to perform one or more of the operations discussed with reference to FIG. 4. For example, the method 400 may be used to obtain network information by devices 104-110, 114, 210, and/or 304 from a server (such as the information server 306) discussed with reference to FIGS. 1-3.

Referring to FIGS. 1-4, at an operation 402, a wireless device (e.g., device 304) may determine whether an information server (e.g., server 306) is accessible. If no information server is discoverable, the wireless device may wait for change in location or other triggers (e.g., change in network conditions, change in out of range indications, change in signal strength, change in reserved battery power, etc.) at an operation 403. Once an information server is accessible, the wireless device may register with the information server at an operation 404. At an operation 406, the wireless device may transmit a request for retrieving information from the information server. At an operation 408, the server may respond and the wireless device may receive the requested information (e.g., information requested at operation 406).

At an operation 410, if the received information at operation 408 indicates to the wireless device that a suitable access network (e.g., AN 2, AN 3, or AN 7) is available, the wireless device may move to the newly identified access network at an operation 412. Otherwise, the method 400 may resume at operation 403. In an embodiment, location data transmitted at operation 406 may be provided in accordance with IEEE 802.11v Specification, Revision P802.11v-D0-08, Feb. 7, 2007. For example, one or more access points (e.g., such as the access point 222) may transmit location data of the wireless device 304 to the information server 306.

Accordingly, in an embodiment, the device 304 may be able to provide its own location information to request networks within that vicinity, for example. Through this mechanism, the device 304 may specify its current location, e.g., in the form of a filter and request for information. In addition, the device 304 may be in motion and being able to specify the speed and its direction information along with coverage range may help optimize the information exchange between the device 304 and the server 306.

In some embodiments, the following information may be provided to enable the device 304 to query the IS 306 about different types of access networks available in the vicinity of the device 304, e.g., based on the location, speed, and/or direction of movement (if any) of the device 304.

In some embodiments, the device 304 may issue an information query using the one or more of the following parameters:

(1) Information Query Parameters; and/or

(2) Information Filter, e.g., based on one or more of the following: location, speed, direction of movement, range of coverage, and/or preferred network operator.

In an embodiment, the above information may be represented in the type-length-value (TLV) format, e.g., MIH_Get_Information.request[Information_Parameters, Information_Filter], where Information_Parameters is Query_Type=TLV or resource description format (RDF) formats, and Information_Filter may be of the TLV format and represented as follows in Table 1 below.

TABLE 1

| Type | Description | Length | Value |
|---|---|---|---|
| FILTER_QUERY_LOCATION | Wireless | Variable | Location may be |
| | Device | | expressed in Latitude, |
| | location | | Longitude and |
| | information | | Altitude; as shown in |
| | | | format below. |
| FILTER_QUERY_SPEED | Wireless | 1 | Value: |
| | Device Speed | | 0: Walking |
| | | | 1: Running |
| | | | 2: Automobile |
| | | | 3: Train |
| | | | 4: Air |
| FILTER_QUERY_DIRECTION | Wireless | 1 | Value: |
| | Device | | 0: NE |
| | Direction of | | 1: NW |
| | travel | | 2: SE |
| | | | 3: SW |
| FILTER_QUERY_COVERAGE_RANGE | Range of | 2 | Range in meters |
| | coverage | | |
| | Wireless | | |
| | Device is | | |
| | interested in | | |
| FILTER_QUERY_PREFERRED_OPERATOR_IDENTIFIER | Network | variable | Operator Id |
| | Operator that | | |
| | the device 304 | | |
| | device may be | | |
| | interested in | | |

Accordingly, some of the embodiments discussed herein may be implemented in various computing platforms (such as notebooks and/or handheld devices) to improve the efficiency of and success rate of vertical handovers. Reducing the amount of data that is communicated over the air-interface may reduce the cost of queries (e.g., reduce latency, improve bandwidth utilization, reduce power consumption by mobile device, etc.) and/or allow mobile devices to better manage different networks.

Additionally, some of the embodiments discussed herein (e.g., with reference to FIGS. 1-5) may facilitate one or more of the following:

(1) Reduced overhead over air-interface: Many networks may have overlapping coverage of varying amount. It may be important for the device 304 to retrieve appropriate network information in an efficient manner. By providing the filters and query parameters such as location, speed, direction, and/or coverage range the client may obtain relevant information from the information server 306 (e.g., as filtered by these parameters). So, the overhead in receiving information over the air interface and sorting through them at the client's end is reduced or avoided;

(2) Higher success rate of handovers: The information filter parameter ‘speed’ may provide a relatively good idea about the extent of granularity and coverage area of network information that the device 304 is looking for, to the server 306. This may provide a performance benefit to the client. For example, the device 304 does not need to obtain information about networks which it may pass relatively quickly based on its speed and/or direction. For example a client traveling in an automobile or train may not be interested in localized wireless fidelity (WiFi) hot spot due to limited coverage at that speed. This reduces possibility of false handovers; and/or

(3) Providing more client based “contextual” information may increase the chances of performing better queries and retrieving more relevant information from the client's perspective.

In an example discussed with reference to FIG. 3, the device 304 may be moving from one location (AN 1) to another (AN 2). Hence, the device 304 may perform the following information query as explained with reference to FIG. 4:

Information_Filter: FILTERQUERY_LOCATION, FILTER_IE_SPEED, FILTER_IE_DIRECTION

Information_Parameters: TYPE_IE_LIST_OF_NETWORKS, TYPE_IE_LIST_OF_OPERATORS

Information_Request: MIH_Get_Info.request[Information_Paramters, Information_Filter]

Subsequently, the server 306 may respond where the information response may include the following responses based on “speed” and coverage of the device 306 as specified by the above query:

If (SPEED==Walking) AN 2; And If (SPEED==Running), AN 2 and AN 9

Thus, based on direction filter, AN 3 through AN 6 information may be eliminated as they would be irrelevant to the device 304. And, based on the current location and speed, relevant network information and properties may be provided to the device 304 by the server 306, e.g., providing query responses that are more efficient.

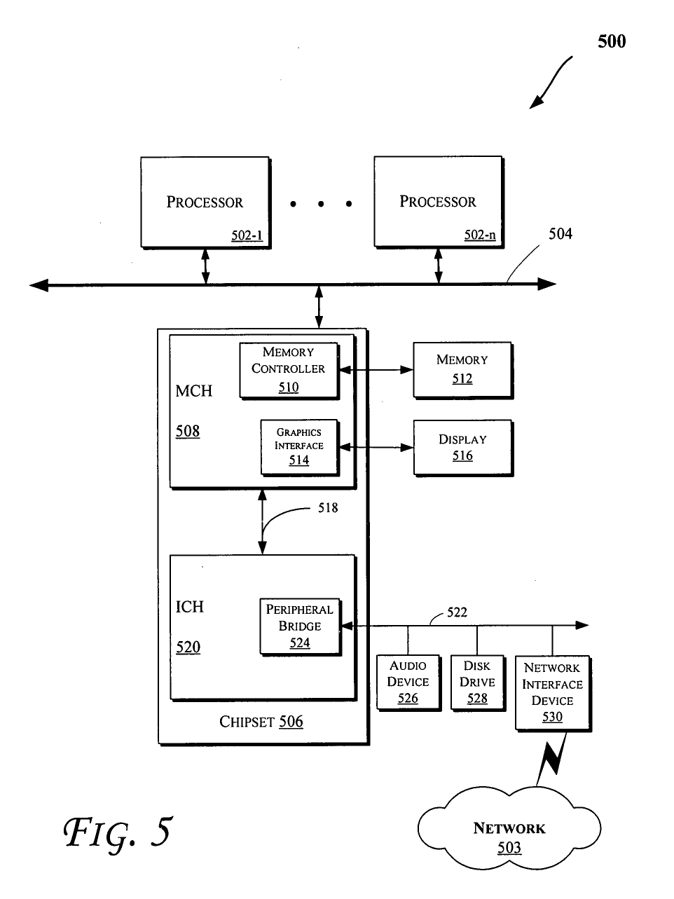

FIG. 5 illustrates a block diagram of an embodiment of a computing system 500. One or more of the devices 104-114 of FIG. 1 and/or devices 210 or 222 of FIG. 2 may comprise the computing system 500. The computing system 500 may include one or more central processing unit(s) (CPUs) 502 or processors that communicate via an interconnection network (or bus) 504. The processors 502 may include a general purpose processor, a network processor (that processes data communicated over a computer network 503), or other types of a processor (including a reduced instruction set computer (RISC) processor or a complex instruction set computer (CISC)). Moreover, the processors 502 may have a single or multiple core design. The processors 502 with a multiple core design may integrate different types of processor cores on the same integrated circuit (IC) die. Also, the processors 502 with a multiple core design may be implemented as symmetrical or asymmetrical multiprocessors. Moreover, the operations discussed with reference to FIGS. 1-4 may be performed by one or more components of the system 500.

A chipset 506 may also communicate with the interconnection network 504. The chipset 506 may include a memory control hub (MCH) 508. The MCH 508 may include a memory controller 510 that communicates with a memory 512. The memory 512 may store data, including sequences of instructions that are executed by the CPU 502, or any other device included in the computing system 500. In one embodiment of the invention, the memory 512 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 504, such as multiple CPUs and/or multiple system memories.

The MCH 508 may also include a graphics interface 514 that communicates with a display 516. In one embodiment of the invention, the graphics interface 514 may communicate with the display 516 via an accelerated graphics port (AGP). In an embodiment of the invention, the display 516 may be a flat panel display that communicates with the graphics interface 514 through, for example, a signal converter that translates a digital representation of an image stored in a storage device such as video memory or system memory into display signals that are interpreted and displayed by the display 516. The display signals produced by the interface 514 may pass through various control devices before being interpreted by and subsequently displayed on the display 516.

A hub interface 518 may allow the MCH 508 and an input/output control hub (ICH) 520 to communicate. The ICH 520 may provide an interface to I/O devices that communicate with the computing system 500. The ICH 520 may communicate with a bus 522 through a peripheral bridge (or controller) 524, such as a peripheral component interconnect (PCI) bridge, a universal serial bus (USB) controller, or other types of peripheral bridges or controllers. The bridge 524 may provide a data path between the CPU 502 and peripheral devices. Other types of topologies may be utilized. Also, multiple buses may communicate with the ICH 520, e.g., through multiple bridges or controllers. Moreover, other peripherals in communication with the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 may communicate with an audio device 526, one or more disk drive(s) 528, and a network interface device 530, which may be in communication with the computer network 503. In an embodiment, the device 530 may be a NIC capable of wireless communication. In an embodiment, the network 503 may be the same or similar to the networks 102 of FIG. 1 and/or 230 of FIG. 2. In one embodiment, the network interface device 530 may include one or more components of the wireless device 210 of FIG. 2. Also, the device 530 may be the same or similar to the device 210 of FIG. 2 in some embodiments. Other devices may communicate via the bus 522. Also, various components (such as the network interface device 530) may communicate with the MCH 508 in some embodiments of the invention. In addition, the processor 502 and the MCH 508 may be combined to form a single chip. Furthermore, the graphics interface 514 may be included within the MCH 508 in other embodiments of the invention.

Furthermore, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 500 may be arranged in a point-to-point (PtP) configuration. For example, processors, memory, and/or input/output devices may be interconnected by a number of point-to-point interfaces.

In various embodiments of the invention, the operations discussed herein, e.g., with reference to FIGS. 1-5, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-5.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a wireless device to transmit a request for information to an information server,
wherein the request is to identify one or more information filters to cause the information server to determine one or more available access networks for the wireless device.

2. The apparatus of claim 1, wherein the information filters comprise one or more of a location, speed, direction of movement, range of coverage, or preferred network operator of the wireless device.

3. The apparatus of claim 1, wherein the available access networks are determined based on one or more of: an operator supporting an access network, a roaming agreement between access network operators, neighbor report for a particular access network, quality of service of an access network, security of an access network, channel conditions of an access network, or properties of a particular point of attachment of an access network.

4. The apparatus of claim 1, further comprising at least one access point to couple the wireless device to the information server.

5. The apparatus of claim 1, wherein at least one of the available access networks is a neighbor of an access network with which the wireless device communicates.

6. The apparatus of claim 1, wherein the information server is to receive location data corresponding to a location of the wireless device from one or more access points.

7. The apparatus of claim 1, wherein the wireless device comprises one or more of a processor, a memory, a transceiver, or an antenna.

8. A method comprising:
transmitting an information query from a wireless device to an information server; and
determining one or more available access networks for the wireless device based on the information query.

9. The method of claim 8, wherein the information query comprises one or more information filters to cause the information server to determine the one or more available access networks for the wireless device.

10. The method of claim 9, wherein the information filters comprise one or more of a location, speed, direction of movement, range of coverage, or preferred network operator of the wireless device.

11. The method of claim 8, further comprising the wireless device moving to one or the available access networks in response to the wireless device receiving data corresponding to the available access networks from the information server.

12. The method of claim 8, further comprising registering the wireless device with the information server.

13. The method of claim 8, further comprising discovering the information server.

14. The method of claim 8, further comprising waiting for a change in conditions if the information server is undiscoverable.

15. The method of claim 14, wherein the change in conditions comprises one or more of a change in location of the wireless device, change in network conditions, change in out of range indications, change in signal strength, or change in reserved battery power of the wireless device.
